(19) United States
(12) Patent Application Publication
(10) Pub. No.: US 2010/0168275 A1
(43) Pub. Date: Jul. 1, 2010

(54) MICROCAPSULES, THEIR USE AND PROCESSES FOR THEIR MANUFACTURE

(76) Inventors: Chun-Tian Zhao, West Yorkshire (GB); Kishor Kumar Mistry, West Yorkshire (GB); Bryan David Grey, West Yorkshire (GB)

Correspondence Address: BASF Performance Products LLC;Patent Department, 540 White Plains Road, P.O. Box 2005, Tarrytown, NY, 10591, US

(21) Appl. No.: 12/663,551

(22) PCT Filed: May 29, 2008
(86) PCT No.: PCT/EP08/56592

§ 371 Date: Dec. 8, 2009

(30) Foreign Application Priority Data
Jun. 12, 2007 (GB) 0711269.1
Oct. 24, 2007 (GB) 0720726.9

(51) Int. Cl. C08K 9/10; C08K 5/09

(52) U.S. Cl. 523/205; 524/300

(57) ABSTRACT

A microcapsule comprising a hydrophobic core within a polymeric shell, in which the core comprises: (a) 10 to 65% by weight of a hydrocarbon liquid or hydrocarbon wax containing hydrocarbon molecules of between 10 and 24 carbon chain length; and (b) 35 to 90% by weight of an aliphatic acid containing at least 6 carbon atoms, based on the total weight of the core. The microcapsules are suitable for use in heat storage systems and especially in heat transfer systems were it is normally necessary for the density of the microcapsules and the carrier fluid to be essentially the same.

The invention relates to microcapsules that have a hydrophobic core surrounded by a polymeric shell in which the core contains a hydrocarbon liquid or a hydrocarbon wax. This shell can be formed from materials conventionally used for formation of microcapsule shells, for instance acrylic resins or aminoplast resins. The microcapsules are suitable for use in thermal energy storage systems or thermal energy transfer systems, especially microencapsulated phase change materials for use in recirculating fluid cooling systems.

There are many instances where it would be desirable to provide capsules comprising a shell surrounding a core material. For instance the core may comprise an active ingredient which is released slowly, such as fragrances, pesticides, medicaments and the like. In some cases it is necessary that the core material is not released from the capsules. This includes encapsulated phase change materials which can be used as products for thermal energy storage or thermal energy transfer products. Such products can for instance the used in fabrics and especially clothing.

Various methods for making capsules have been proposed in the literature. For instance it is known to encapsulate hydrophobic liquids by dispersing the hydrophobic liquid into an aqueous medium containing a melamine formaldehyde pre-condensate and then reducing the pH resulting in an impervious aminoplast resin shell wall surrounding the hydrophobic liquid.

Variations of this type of process are described in GB-A-2073132, AU-A-27028/88 and GB-A-1507739, in which the capsules are preferably used to provide encapsulated inks for use in pressure sensitive carbonless copy paper. WO-A-9924525 describes microcapsules containing as a core a lipophilic latent heat storage material with a phase transition at −20 to 120° C. The capsules are formed by polymerizing 30 to 100 wt. % C1-24 alkyl ester of (meth)acrylic acid, up to 80 weight % of a di- or multifunctional monomer and up to 40 weight % of other monomers. The microcapsules are said to be used in mineral molded articles.

WO-A-01/54809 provides capsules which can easily be incorporated into fibres without suffering the loss of an active core material during the spinning process. The capsules contain a polymeric shell which is formed from a monomer blend comprising A) 30 to 90% by weight methacrylic acid, B) 10 to 70% by weight alkyl ester of (meth)acrylic acid which is capable of forming a homopolymer of glass transition temperature in excess of 60° C. and C) 0 to 40% by weight other ethylenically unsaturated monomer.

EP-A-1382656 relates to a heat absorbing particle having a core shell configuration which is described as having a diameter of between 1 and 1000 μm and comprising a shell portion made of high molecular weight polymer selected from melamine formaldehyde, urea formaldehyde resins, polyurethanes, and acrylics. The core portion is said to contain a heat absorbing material. This heat absorbing material is selected from any of straight chain alkanes, alcohols and organic acids. Thus any one of these substances would be chosen as the heat absorbing material.

WO 2005 105291 describes a composition comprising particles which comprise a core material within a polymeric shell, in which the core material comprises a hydrophobic substance. A special combination of features in which the polymeric shell must form at least 8% of the total weight of particles and polymeric shell is formed from a monomer blend that includes 5 to 90% by weight of an ethylenically unsaturated water soluble monomer, 5 to 90% by weight of a multifunctional monomer, and 0 to 55% by weight other monomer and in which the proportions of these monomers are chosen such that the particles exhibit a half height of at least 350° C. It is also suggested that the microcapsules can contain a variety of active materials. An extensive list of possible actives is given including UV absorbers, flame retardants, pigments, dyes, enzymes and detergent builders. Of the pigments identified a variety of organic and inorganic materials are included such as iron oxide pigments.

U.S. Pat. No. 5,456,852 describes microencapsulated phase change materials with the objective of overcoming a phenomenon known as supercooling in which the melting temperature and freezing temperature of the phase change material are quite different. This is overcome by including a high melting compound with the compound capable of undergoing phase transitions. A long list of possible high melting compounds is proposed including fatty acids, alcohols and amides. Preferred compounds capable of undergoing phase transitions are said to be straight chain aliphatic hydrocarbons having 10 or more carbon atoms.

Japanese patent application JP-A-9031451 describes a thermal storage medium containing an organic compound causing a phase change and a specific nucleating agent which is capable of preventing supercooling. Thus the thermal storage medium comprises (A) and organic compound causing a phase change, for instance a straight chain aliphatic hydrocarbon of at least 10 carbon atoms together with (B) a nucleating agent which is an amine derivative, an alcohol derivative or a carboxylic acid derivative of the component (A). The nucleating agent (B) is said to be present in an amount between 0.5 and 30 weight %.

A further important area of application for phase change materials is in active temperature regulation systems employing recirculating fluids. It is well known that the efficiency of a heat transfer fluid can be increased by the introduction of micro encapsulated phase change materials. U.S. Pat. No. 3,596,713 describes using phase change materials in a heat transfer fluid containing particles made from a phase change material and an impervious housing. The particles expand on absorption of heat resulting in an increase in buoyancy resulting in a natural convection current. However, the phase change material within the particles has a lower density than conventional aqueous transfer fluids. Such a system would therefore be of limited application for aqueous carrier fluids or other fluids of higher density.

Typically microencapsulated phase change materials tend to have densities of significantly below 1 g/cm³ and often below 0.9 g/cm³ and in some cases between 0.7 and 0.8 g/cm³. Consequently, in aqueous heat transfer systems, such microcapsules will tend to migrate to the upper portion of the aqueous carrier fluid. Therefore, such phase change material microcapsules will tend not to be carried efficiently by the carrier fluid which will impair heat transfer.

U.S. Pat. No. 5,723,059 describes heat transfer fluids containing particles in which halocarbons are included in the carrier fluid. The particles are designed to remain dispersed within the dispersing fluid by altering the composition of the carrier fluid to match the density of the particles. However, a change in the composition, for instance due to the preferential evaporation of one of components, would lead to a change in density and hence a change in the buoyancy of the particles.

US 2004 001923 describes heat transfer fluids in which particles containing phase change material are dispersed within a carrier fluid. The dispersion is rendered stable by adjusting the density of the particles to equate to the density of the carrier fluid. This is said to be achieved by including metal particles or other high-density materials within the particles. However, no indication is given as how the particles can be made. Conventional methods of preparing such particles may give an uneven distribution of metal particles or other high-density materials and consequently prevent the desired density to be achieved consistently.

GB patent application 0623748.1 (Attorney Docket No ME/3-22390) unpublished at the date of filing of the present application, describes microcapsules for heat transfer and thermal energy storage comprising a core containing a hydrophobic liquid or wax within a polymeric shell, in which solid particles insoluble in the hydrophobic liquid or wax are distributed throughout the core, wherein an oil soluble dispersant polymer is adhered to the surface of the solid insoluble particles. Such microcapsules are said to more consistently exhibit a desired density which can be chosen to be the same as the carrier fluid.

A wide range of different densities can be chosen by incorporating higher against the solids into the microcapsules. However, such microcapsules tend to suffer the disadvantage in that they have a reduced enthalpy by comparison to microcapsules without the high-density solids. This reduced enthalpy means that a greater concentration of such microcapsules would be needed to achieve the same effect.

An object of the present invention is to provide microcapsules of a desired density. In particular it is desirable to achieve this consistently. Furthermore, it would particularly desirable to achieve this in combination with avoiding the disadvantage of reduced enthalpy.

The present invention provides a microcapsule comprising a hydrophobic core within a polymeric shell, in which the core comprises:
(a) 10 to 65% by weight of a hydrocarbon liquid or hydrocarbon wax containing hydrocarbon molecules of between 10 and 24 carbon chain length; and
(b) 35 to 90% by weight of an aliphatic acid containing at least 6 carbon atoms,
   based on the total weight of the core.

In general the shell should form at least 5% by weight based on the total weight of microcapsule. Preferably in the microcapsule hydrophobic core forms an amount between 50 and 95% by weight and the shell in an amount of between 5 and 50% by weight in which all percentages of based on the total weight of the microcapsule.

More preferably the hydrophobic core is present in the amount between 60 and 92% by weight of microcapsule and particularly preferably between 70 and 92%, especially between 80 and 90%, more especially still between 85 and 90%. The shell should preferably form between 8 and 40% by weight of the microcapsule and in particular between 8 and 30%, especially between 10 and 20% and more preferably still between 10 and 15%.

Preferably the core in the microcapsule comprises between 20 and 60% by weight of the hydrocarbon liquid or hydrocarbon wax and between 40 and 80% by weight of the aliphatic acid. More preferably the microcapsule comprises between 40 and 70% in hydrocarbon liquid or hydrocarbon wax and between 30 and 60% by weight of the aliphatic acid. It is particularly preferred that the hydrophobic core comprises hydrocarbon liquid or hydrocarbon wax in an amount between 45 and 60% and the aliphatic acid in an amount between 40 and 55% by weight.

The aliphatic acid should have at least 6 carbon atoms since such aliphatic acids tend to have low solubility in water, for instance below 5 g/cm³ water at 25° C. It is also desirable that the aliphatic acid and hydrocarbon liquid or hydrocarbon wax are miscible with each other or that one will dissolve in the other. Alternatively, one of components may be readily dispersible throughout the other component. In a further alternative at least portion of the aliphatic acid is preferentially located in the outer regions of the core whilst the hydrocarbon liquid or hydrocarbon wax is preferentially located in the inner region of the core.

Preferably, the hydrocarbon liquid or hydrocarbon wax and the aliphatic acid are uniformly distributed throughout each other.

The aliphatic acid may be straight chained or branched or cyclic. Typically the aliphatic acid will contain between 6 and 22 carbon atoms and desirably can be selected from one or more of the straight chain aliphatic acids hexanoic acid, heptanoic acid, octanoic acid, nonanoic acid, decanoic acid, undecanoic acid, dodecanoic acid, tridecanoic acid, tetradecanoic acid (Mystyric acid), pentadecanoic acid, hexadecanoic acid, heptadecanoic acid, octadecanoic acid (stearic acid), nonadecanoic acid, cosanoic acid, eicosanoic acid, and docosanoic acid (behenic acid). Any branched isomers corresponding to any of the above named aliphatic acids may also be useful.

When the microcapsules are used in active temperature control systems which use a heat transfer fluid in general the carrier fluid would have a higher density than the microcapsules in the absence of the particles. Therefore in order for the microcapsules to remain distributed throughout the carrier fluid without floating to the surface it would be necessary for them to have an equivalent density to the carrier fluid. Consequently, the insoluble particles will usually have a greater density than the hydrophobic liquid or wax.

Therefore when the microcapsules are to be used in an aqueous carrier fluid, for example in a heat transfer system, it is desirable that the microcapsule exhibits a density as close to that of the aqueous fluid as possible. Generally this will be at least 0.9 g/cm³ at 25° C. and usually in the range of between 0.9 and 1.05 g/cm³. Preferably, the microcapsules will exhibit a density between 0.95 and about 1 g/cm³ and especially substantially around 1 g/cm³ at 25° C. It is therefore desirable in such a system to choose an aliphatic acid that has a density greater than that of the hydrocarbon liquid or hydrocarbon wax. In general the preferred aliphatic acid will have a density of at least 0.80 g/cm³ and often at least 0.85 g/cm³. Normally the aliphatic acid will not have a density that exceeds 1 g/cm³ and typically this will not exceed 0.90 g/cm³.

We have found that the combination of hydrocarbon liquid or hydrocarbon wax with the aliphatic acid as core material, once encapsulated in a microcapsule wall the density of the microcapsules can be increased significantly beyond the density in the absence of the aliphatic acid. An appropriate choice of hydrocarbon liquid or hydrocarbon wax can be made in combination with the shell wall contents such that microcapsules with the desired density can be achieved, for instance around 1 g/cm³.

The hydrocarbon liquid or hydrocarbon wax may be any straight chained or branched or cyclic alkane. It should contain between 10 and 24 carbon atoms and desirably can be selected from one or more of the straight chain paraffins decane, undecane, dodecane, tridecane, tetradecane, pentadecane, hexadecane, heptadecane, octadecane, nonadecane, cosane, eicosane, docosane, tricosane, and tetracosane. Any branched isomers corresponding to any of the above named aliphatic acids may also be useful. Typical cyclic hydrocarbon liquids or waxes include cyclohexane, cyclooctane, cyclodecane.

It is preferred that the hydrophobic core of the microcapsule has a melting point at a temperature between −30° C. and 150° C. Generally the core material has a melting point at between 20 and 80° C., often around 40° C.

Microcapsules of the present invention may be formed from a number of different types of materials including aminoplast materials, particularly using melamine aldehyde condensates and optionally urea e.g. melamine-formaldehyde, urea-formaldehyde and urea-melamine-formaldehyde, gelatin, epoxy materials, phenolic, polyurethane, polyester, acrylic, vinyl or allylic polymers etc. Microcapsules with acrylic copolymer shell material formed from acrylic monomers have been found to be particular suitable. Other methods of making the microcapsules included interfacial polymerisation, other techniques resulting in polyurethane capsules. It is considered that any other general techniques for producing microcapsules may also be suitable for the present invention. These will need to be adapted by reference to the processes described in detail herein.

Included in the present invention is a process of manufacturing microcapsules in which the polymeric shell is formed from ethylenically unsaturated monomers. Thus we provide a process for making microcapsules comprising a hydrophobic core within a polymeric shell in which the core comprises:
(a) 10 to 65% by weight of a hydrocarbon liquid or hydrocarbon wax containing hydrocarbon molecules of between 10 and 24 carbon chain length; and
(b) 35 to 90% by weight of an aliphatic acid of chain length at least 6 carbon atoms,
   based on the total weight of the core,
   comprising the steps,
1) providing a monomer blend comprising,
   i) hydrophobic mono functional ethylenically unsaturated monomer,
   ii) polyfunctional ethylenically unsaturated monomer, and
   iii) other mono functional monomer(s),
2) combining the monomer blend, the aliphatic acid with the hydrocarbon liquid or molten hydrocarbon wax to form a monomer solution,
3) providing an aqueous phase, optionally containing polymeric stabiliser or emulsifying agent,
4) homogenising the monomer solution into the aqueous phase containing to form an emulsion,
5) subjecting the emulsion to polymerisation conditions, and
6) polymerising the monomer blend to form a dispersion of microcapsules in the aqueous phase.

The microcapsule shell may be structured, for instance branched or cross-linked. In view of the presence of at least one polyfunctional ethylenically unsaturated monomer in the stated amounts the microcapsule shell will preferably tend to be cross-linked. Generally such cross-linking will render a polymeric shell insoluble although the polymeric shell may be capable of absorbing certain solvent liquids provided that the polymeric shell does not dissolve.

Preferably the monomer blend which will form the polymeric shell is formed from
1 to 95% by weight hydrophobic mono functional ethylenically unsaturated monomer,
5 to 99% by weight polyfunctional ethylenically unsaturated monomer and
0 to 60% by weight other mono functional monomer,
   based on the weight of the polymeric shell in which the components should total 100%.

More preferably the amount of hydrophobic mono functional ethylenically unsaturated monomer is between 5 and 30% by weight and the amount of polyfunctional ethylenically unsaturated monomer is between 70 and 95% by weight, based on the weight of the monomer blend. The amount of other monomer may be as much as 55% by weight and more preferably between 5 and 55% by weight. A particularly preferred monomer blend comprises between 5 and 25% by weight of hydrophobic mono functional ethylenically unsaturated monomer, between 35 and 45% by weight of polyfunctional ethylenically unsaturated monomer and between 40 and 50% by weight of other mono functional monomer.

In some instances it may be desirable to include more than one monomer from each component. For instance it may be desirable to include two or more hydrophobic mono functional ethylenically unsaturated monomers and/or two or more polyfunctional ethylenically unsaturated monomers and/or two or more other mono functional monomers.

The hydrophobic mono functional ethylenically unsaturated monomer may be any suitable monomer that carries one ethylenically group and as a solubility in water are below 5 g per 100 ml of water at 25° C., but usually less than 2 or 1 g/100 cc. The solubility in water may be zero or at least below detectable levels. Desirably the hydrophobic monomer will include one or more of styrene or derivatives of styrene, esters of mono ethylenically unsaturated carboxylic acids. Preferably the hydrophobic monomer will include alkyl esters of methacrylic acid or acrylic acid. More preferably the hydrophobic monomer is a C1-12 alkyl ester of acrylic or methacrylic acid. Such hydrophobic monomers may include for instance acrylic or methacrylic esters that are capable of forming a homopolymer that has a glass transition temperature (Tg) of at least 60° C. and preferably at least 80° C. Specific examples of these monomers include styrene, methyl methacrylate, tertiary butyl methacrylate, phenyl methacrylate, cyclohexyl methacrylate and isobornyl methacrylate.

Glass transition temperature (Tg) for a polymer is defined in the Encyclopaedia of Chemical Technology, Volume 19, fourth edition, page 891 as the temperature below which (1) the transitional motion of entire molecules and (2) the coiling and uncoiling of 40 to 50 carbon atom segments of chains are both frozen. Thus below its Tg a polymer would not to exhibit flow or rubber elasticity. The Tg of a polymer may be determined using Differential Scanning Calorimetry (DSC).

The polyfunctional ethylenically unsaturated monomer can be any monomer and that induces cross-linking during the polymerisation. Preferably it is a diethylenically unsaturated or polyethylenically unsaturated monomer i.e. carrying two or more ethylenically unsaturated groups. Alternatively the polyfunctional ethylenically unsaturated monomer may contain at least one ethylenically unsaturated group and at least one reactive group capable of reacting with other functional groups in any of the monomer components. Preferably, the multifunctional monomer is insoluble in water or at least has a low water-solubility, for instance below 5 g/100 cc at 25° C., but usually less than 2 or 1 g/100 cc. The solubility in water can be zero or at least below detectable levels at 25° C. In addition the multifunctional monomer should be soluble or at least miscible with the hydrocarbon substance of the core material. Suitable multifunctional monomers include divinyl benzene, ethoxylated bisphenol A diacrylate, propoxylated neopentyl glycol diacrylate, tris(2-hydroxyethyl) isocyanurate triacrylate, trimethylolpropane triacrylate and an alkane diol diacrylate, for instance 1,3-butylene glycol diacrylate, 1,6-hexanediol diacrylate but preferably 1,4-butanediol diacrylate.

The other mono functional monomer may be any monomer that has a single polymerisable group. Preferably it will be any ethylenically unsaturated monomer. Typically these other monomers include esters selected from the group consisting of an ethylenically unsaturated carboxylic acid and salts thereof, amino alkyl esters of ethylenically unsaturated carboxylic acid or salts thereof, N-(amino alkyl) derivatives of acrylamide or methacrylamide or salts thereof, other water soluble acrylic monomers including acrylamide, esters of ethylenically unsaturated carboxylic acid, water soluble styrene derivatives, methacrylic acid or salts, acrylic acid or salts, vinyl sulphonic acid or salts, allyl sulphonic acid or salts, itaconic acid or salts, 2-acrylamido-2-methyl propane sulphonic acid or salts, acrylamide and vinyl acetate.

The aqueous phase provided may suitably contain an emulsification system which desirably could be either a stabiliser or a surfactant, typically and emulsifier. This may be formed by dissolving a suitable emulsification system, for instance containing an effective amount of stabiliser or surfactant into water. Suitably an effective amount of stabiliser or surfactant (preferably emulsifier) may be up to 50% by weight or higher based on the weight of the monomer blend that forms the polymeric shell. Preferably the amount of stabiliser or surfactant will be within the range of 1% and 40%, more preferably around 10% to 30%, based on the weight of the monomer blend that forms the polymeric shell.

Suitably the stabilisers or emulsifiers are soluble or dispersible in water at 25° C., thus enabling the stabiliser or emulsifier to be dispersed or preferably dissolved in the aqueous phase. Generally stabilisers or emulsifiers preferably have a high HLB (Hydrophilic Lipophilic Balance) is dissolved into water prior to emulsification of the monomer solution. It will be preferably the HLB will be at least 4 and for instance up to 12 or higher and more preferably at least 6, more preferably still between 8 and 12. Preferably the monomer solution is be emulsified into water with a polymerisation stabiliser dissolved therein.

In this process it is preferred that a stabiliser is added into the aqueous phase in order to help emulsification and also formation of the microcapsules. The stabiliser may be a suitable material that is water soluble or at least water dispersible. Preferably it will be an amphipathic polymeric stabiliser. More preferably the stabiliser will be a hydroxy containing polymer, for instance it may be polyvinyl alcohol, hydroxy ethyl cellulose, methyl cellulose, hydroxy propyl cellulose, carboxy methyl cellulose and methyl hydroxy ethyl cellulose. Generally it is preferred to use polyvinyl alcohol which has been derived from polyvinyl acetate, wherein between 85 and 95%, preferably around 90%, of the vinyl acetate groups have been hydrolysed to vinyl alcohol units. Other stabilising polymers may additionally be used.

The process may employ an additional material is to promote stability as part of an emulsifying system, for instance emulsifiers, other surfactants and/or other polymerisation stabilisers.

Other stabilising substances that may be used in the process preferably in addition to the stabilising polymer include ionic monomers. Typical cationic monomers include dialkyl amino alkyl acrylate or methacrylate including quaternary ammonium or acid addition salts and dialkyl amino alkyl acrylamide or methacrylamide including quaternary ammonium or acid addition salts. Typical anionic monomers include ethylenically unsaturated carboxylic or sulphonic monomers such as acrylic acid, methacrylic acid, itaconic acid, allyl sulphonic acid, vinyl sulphonic acid especially alkali metal or ammonium salts. Particularly preferred anionic monomers are ethylenically unsaturated sulphonic acids and salts thereof, especially 2-acrylamido-2-methyl propane sulphonic acid, and salts thereof. The other stabilising substance may be used in any effective amount, usually at least 0.01% and preferably up to 10% by weight of the monomer blend that forms the polymeric shell, and more preferably between 0.5% and 5%.

The polymerisation step may be effected by subjecting the aqueous monomer solution to any conventional polymerisation conditions. Generally polymerisation is effected by the use of suitable initiator compounds. Desirably this may be achieved by the use of redox initiators and/or thermal initiators. Typically redox initiators include a reducing agent such as sodium sulphite, sulphur dioxide and an oxidising compound such as ammonium persulphate or a suitable peroxy compound, such as tertiary butyl hydroperoxide etc. Redox initiation may employ up to 1000 ppm, typically in the range 1 to 100 ppm, normally in the range 4 to 50 ppm.

Preferably the polymerisation step is effected by employing a thermal initiator alone or in combination with other initiator systems, for instance redox initiators. Thermal initiators would include any suitable initiator compound that releases radicals at an elevated temperature, for instance azo compounds, such as azobisisobutyronitrile (AZDN), 4,4′-azobis-(4-cyanovaleric acid) (ACVA) or t-butyl perpivilate or peroxides such as lauroyl peroxide. Typically thermal initiators are used in an amount of up 50,000 ppm, based on weight of monomer. In most cases, however, thermal initiators are used in the range 5,000 to 15,000 ppm, preferably around 10,000 ppm. Preferably a suitable thermal initiator with the monomer prior to emulsification and polymerisation is effected by heating the emulsion to a suitable temperature, for instance 50 or 60° C. or higher.

Also included in the present invention is a process for manufacturing microcapsules comprising a hydrophobic core within a polymeric shell, in which the core comprises:
(a) 10 to 65% by weight of a hydrocarbon liquid or wax containing hydrocarbon molecules of between 10 and 24 carbon chain length; and
(b) 35 to 90% by weight of an aliphatic acid of chain length at least 6 carbon atoms,
   based on the total weight of the core,
   comprising the steps,
1) forming a hydrophobic phase comprising the aliphatic acid and the hydrocarbon liquid or molten hydrocarbon wax,
2) forming an aqueous monomer solution comprising a water-soluble amine formaldehyde resin, a water-soluble carboxylic acid which is preferably formic acid, a water-soluble anionic polymer and optionally a polymeric stabiliser or emulsifying agent,
3) forming an aqueous phase by partially reacting the components of the aqueous monomer solution optionally raising the temperature of the aqueous solution,
4) homogenising the monomer solution into the aqueous phase containing to form an emulsion,
5) subjecting the emulsion to polymerisation conditions, and
6) polymerising the monomer to form a dispersion of microcapsules in the aqueous phase.

Preferably the reactants in the emulsion are partially reacted by an ageing period optionally at an elevated temperature. Preferably the emulsion is initially maintained at a temperature of between 20 and 40° C. More preferably this will be for a period between 90 and 150 minutes.

Desirably the emulsion is subjected to temperatures of above 40° C. and preferably at least 50° C. in order to effect polymerisation and more preferably temperatures between 60 and 80° C. Higher temperatures may be employed although generally it is unlikely to be above 90° C. and usually significantly below. This polymerisation step results in the formation of microcapsules. Generally this step will require at least 30 minutes and preferably at least 1 hour. Considerably longer periods of time may be employed, for instance up to 150 minutes although longer periods may be required in some cases. In general we find that this step is normally completed within two hours.

The water-soluble anionic polymer is preferably a polymer of ethylenically unsaturated monomers in which at least one is anionic or potentially anionic. More preferably the polymer is acrylic, especially copolymers of acrylamide sodium acrylate or hydrolysed polyacrylamides. Generally these polymers will have a molecular weight of at least 10,000 g/mol and preferably at least 50,000 g/mol. Often the molecular weight can be as high as 1,000,000 g/mol but preferably below 500,000 g/mol. This polymer can be prepared by conventional techniques known in the art.

Other general matters for preparing microcapsules of amino plastic resins are described in GB-A-2073132, AU-A-27028/88 and GB-A-1507739 particularly in the respective examples. These may be used in the present invention provided that they are adapted in accordance with the above detailed description.

The microcapsules of the present invention, for all types of microcapsule wall, desirably may have an average particle size diameter is less than 10 microns.

Generally the average particle size diameter tends to be much smaller, often less than 2 microns and typically the average particle diameter will be between 200 nm and 2 microns. Preferably the average particle size diameter is in the range 500 nm and 1.5 microns usually around 1 micron. Average particle size is determined by a Sympatec particle size analyser according to standard procedures well documented in the literature.

The microcapsules of the present invention may be used in a variety of applications including textiles (for instance within the body of the fibre or alternatively coating the fibre or textile), automotive applications (including use in circulatory cooling fluids or a coolant within the interior design), construction industry (for instance in passive or active ventilation systems), or heat transfer fluids (as a capsule within a modified heat transfer fluid). It is possible to incorporate the microcapsules of the present invention into any suitable article, for instance fibres, textile products, ceramics, coatings etc. Thus a further aspect of the present invention we provide an article comprising microcapsules. Hence according to the invention it is possible to provide an article which comprises encapsulated flame retardants, UV absorbers, active dye tracer materials or phase change material. In the case of encapsulated flame retardants it would be desirable for the flame retardant to be retained during any processing steps such as fibre formation.

A particular benefit of the microcapsules of the present invention is that they can be prepared such that they have a desired density.

Thus we provide a process in which the microcapsules have a chosen density, comprising the additional steps,
1) identifying the chosen density,
2) determining the density of microcapsules comprising a core containing a hydrophobic liquid or wax within a polymeric shell,
3) determining the required amount of the insoluble solid particles in order to provide the microcapsules with the chosen density, and
4) combining the required amount of the insoluble solid particles in the respective process.

The microcapsules may be dispersed in a liquid, for instance a carrier liquid as part of a heat transfer fluid. Thus we provide a dispersion of microcapsules in a liquid in which the microcapsules comprise a core containing a hydrophobic liquid or wax within a polymeric shell, in which solid particles insoluble in the hydrophobic liquid or wax are distributed throughout the core, wherein an oil soluble dispersant polymer is adhered to the particle surface.

An advantage of the microcapsules of the present invention is that they can be manufactured such that their density matches the density of the liquid in which they are to be dispersed. Consequently, it is preferred that the dispersion of microcapsules in the liquid have substantially the same density.

We further provide a process of preparing a dispersion of microcapsules in a liquid in which the microcapsules comprise a hydrophobic core within a polymeric shell, in which the core comprises:
(a) 10 to 65% by weight of a hydrocarbon liquid or hydrocarbon wax containing hydrocarbon molecules of between 10 and 24 carbon chain length; and
(b) 35 to 90% by weight of an aliphatic acid of chain length at least 6 carbon atoms,
   based on the total weight of the core.

An advantage of the microcapsules of the present invention is that they can be manufactured such that their density matches the density of the liquid in which they are to be dispersed. Consequently, it is preferred that the dispersion of microcapsules in the liquid have substantially the same density.

We further provide a process of preparing a dispersion of microcapsules in a liquid in which the microcapsules comprise a hydrophobic core within a polymeric shell, in which the core comprises:
(a) 10 to 65% by weight of a hydrocarbon liquid or hydrocarbon wax containing hydrocarbon molecules of between 10 and 24 carbon chain length; and
(b) 35 to 90% by weight of an aliphatic acid of chain length at least 6 carbon atoms,
   based on the total weight of the core.

Preparation of such a dispersion of microcapsules may desirably be prepared so that the density of the microcapsules is substantially the same the density of the liquid into which they are to be dispersed.

This may be achieved conveniently by the steps:
1) identifying the density of said liquid,
2) determining the density of microcapsules comprising a core containing a hydrophobic liquid or wax within a polymeric shell,
3) determining the required amount of the insoluble solid particles in order to provide the microcapsules with the chosen density,
4) preparing said microcapsules as defined above, and
5) combining said microcapsules with said liquid in order to form the dispersion.

The following examples illustrate the invention.

### EXAMPLES

### Particle Size Analysis

Particle size analysis was conducted using a Sympatec HELOS Analyzer (ex Sympatec (GmBH)) fitted with a QUIXCELL unit employing either R1 or R4 lens configuration.

### Example 1

An oil phase is prepared by mixing molten waxes comprising of 40 g of 54/56 French paraffin wax (melting point ˜55° C., supplied by Meade-King, Robinson) and 60 g of Myristic acid (melting point: 52-54° C., supplied by Sigma-Aldrich) at 60° C.

An aqueous phase is prepared by first mixing 8.3 g of 18% Alcapsol P604 (anionic polyacrylamide solution available from Ciba Specialty Chemicals) and 126 g of water. Next, the mixture is warmed to 60° C. and then 24.3 g of 70% melamine-formaldehyde resin (Beetle Resin PT336 ex BIP) and 0.5 g of 95% formic acid are added. The resulting aqueous phase is stirred at 60° C. for about 90 seconds to partly condense the melamine-formaldehyde resin. The oil and aqueous phases are emulsified together using a high shear homogeniser (Silverson L4RT model) at 4000 rpm for about 6 minutes to form a stable oil-in-water emulsion. The formed emulsion is transferred into 700 ml flask set up in a thermostatic water bath. The flask content is stirred mechanically at 60° C. for 3 hour to complete the encapsulation of the wax mixture. After this period, the encapsulation mass is cooled to room temperature and neutralised with 0.65 g of 46% sodium hydroxide solution. The final product is a fluid dispersion of wax microcapsules having a mean particle size diameter of 30.4 μm.

### Example 2

The encapsulation process described in Example 1 above is repeated with the exception of the oil phase comprised of 50 g of 54/56 French paraffin wax and 50 g of Myristic acid.

The product produced is a fluid dispersion of wax microcapsules having a mean particle size diameter of 32 μm.

### Example 3

### Acrylic Based Microencapsulation of a 54/56 Wax: Myristic Acid Blend

A first oil phase is prepared by mixing 50 g of 54/56 French paraffin wax with 50 g of myristic acid at 60° C. To this wax mixture is dissolved 3.28 g of methyl methacrylate, 8.68 g of butane diol diacrylate and 9.70 g of methacrylic acid followed by 0.22 g of Alperox LP (lauroyl peroxide). This oil phase is mixed until the Alperox fully dissolves.

Separately, an aqueous phase is prepared by mixing 5.4 g of polyvinyl alcohol (Gohsenol GH20R ex Nippon Gohseii), 122 g of water and 0.64 g of sodium AMPS (50% active ex Lubrizol, France).

The aqueous phase is warmed to 60° C. and to it is added the above oil phase under the Silverson L4R laboratory homogenizer to form oil-in-water. After 10 minutes a stable emulsion is obtained. The resultant emulsion is transferred into a reaction vessel equipped for polymerisation submerged in a water bath set @ 80° C. After three hours at 80° C. temperature, ammonium persulphate solution (0.22 g in 10 ml water) is added and the temperature increased to 90° C. After a further two hours at this higher temperature, the mixture is cooled to room temperature to yield a dispersion of wax microcapsules having a polymer shell with a mean particle size of 2 μm.

### Comparative Example 1

Example 1 described above is repeated with the exception that the oil phase comprised totally of 100 g of 54/56 French wax. The rest of the process conditions remained identical to Example 1.

The resulting fluid dispersion contained wax microcapsules having a mean particle size diameter of 24.8 microns.

### Comparative Example 2

Example 1 described above is repeated with the exception that the oil phase comprised totally of 100 g of myristic acid. The rest of the process conditions remained identical to Example 1.

The resulting fluid dispersion contained wax microcapsules having a mean particle size diameter of 27.7 microns.

### Comparative Example 3

Example 3 described above is repeated with the exception that the oil phase comprised of 100 g of 54/56 French wax instead of the 50/50 blends of the two waxes. The rest of the process conditions remained identical to Example 3.

The resulting fluid dispersion contained wax microcapsules having an average particle size diameter of 2.2 microns.

### Sedimentation Data

The microcapsule dispersion resulting from Example 1-3 and Comparative Example 1-3 were subjected to dispersion stability test for creaming and or sedimentation of the microcapsules on storage with time. The results are given in Table 1.

TABLE 1
Microcapsule dispersion stability on storage at 25° C. with time.

| Microcapsule | | | | |
|---|---|---|---|---|
| Dispersion | Dispersion Stability on Storage with Time (days) | | | |
| Sample from | 0 day | 1 day | 5 days | 15 days |
| Example 1 | Stable | Stable | Stable | Stable |
| Example 2 | Stable | Stable | Stable | Slight |
| | | | | creaming |
| Example 3 | Stable | Stable | Stable | Stable |
| Comparative | Stable | Creaming | Creaming | Creaming |
| Example 1 | | | | |
| Comparative | Stable | Sedi- | Sedi- | Sedi- |
| Example 2 | | mentation | mentation | mentation |
| Comparative | Stable | Stable | Creaming | Creaming |
| Example 3 | | | | |

From Table 1 it is clearly apparent that wax microcapsule dispersions made according to the invention are stable on storage and the microcapsules remain suspended within the carrier fluid. The wax microcapsules dispersions resulting from comparative examples 1-3 on storage are physically unstable and the microcapsules cream to the top and pack to a solid mass.

1. A microcapsule comprising a hydrophobic core within a polymeric shell, in which the core comprises:
(a) 10 to 65% by weight of a hydrocarbon liquid or hydrocarbon wax containing hydrocarbon molecules of between 10 and 24 carbon chain length; and
(b) 35 to 90% by weight of an aliphatic acid containing at least 6 carbon atoms, based on the total weight of the core.

2. A microcapsule according to claim 1 comprising
50 to 92% by weight core and
8 to 50% by weight shell,
based on total weight of microcapsule.

3. A microcapsule according to claim 1 in which the aliphatic acid has a chain length of between 6 and 22 carbon atoms.

4. A microcapsule according to claim 1 in which the hydrophobic core has a melting point at a temperature between −30° C. and 150° C.

5. A microcapsule according to claim 1 in which the polymeric shell is formed from either an acrylic resin or an aminoplast resin.

6. A process of manufacturing microcapsules comprising a hydrophobic core within a polymeric shell, in which the core comprises:
(a) 10 to 65% by weight of a hydrocarbon liquid or wax containing hydrocarbon molecules of between 10 and 24 carbon chain length; and
(b) 35 to 90% by weight of an aliphatic acid of chain length at least 6 carbon atoms, based on the total weight of the core,
comprising the steps,
1) providing a monomer blend comprising,
i) hydrophobic mono functional ethylenically unsaturated monomer,
ii) polyfunctional ethylenically unsaturated monomer, and
iii) other mono functional monomer(s),
2) combining the monomer blend, the aliphatic acid with the hydrocarbon liquid or molten hydrocarbon wax to form a monomer solution,
3) providing an aqueous phase, optionally containing polymeric stabiliser or emulsifying agent,
4) homogenising the monomer solution into the aqueous phase containing to form an emulsion,
5) subjecting the emulsion to polymerisation conditions, and
6) polymerising the monomer blend to form a dispersion of microcapsules in the aqueous phase.

7. A process of manufacturing microcapsules comprising a hydrophobic core within a polymeric shell, in which the core comprises:
(a) 10 to 65% by weight of a hydrocarbon liquid or wax containing hydrocarbon molecules of between 10 and 24 carbon chain length; and
(b) 35 to 90% by weight of an aliphatic acid of chain length at least 6 carbon atoms, based on the total weight of the core,
comprising the steps,
1) forming a hydrophobic phase comprising the aliphatic acid and the hydrocarbon liquid or molten hydrocarbon wax,
2) forming an aqueous monomer solution comprising a water-soluble amine formaldehyde resin, a water-soluble carboxylic acid which is preferably formic acid, a water-soluble anionic polymer and optionally a polymeric stabiliser or emulsifying agent,
3) forming an aqueous phase by partially reacting the components of the aqueous monomer solution optionally raising the temperature of the aqueous solution,
4) homogenising the monomer solution into the aqueous phase containing to form an emulsion,
5) subjecting the emulsion to polymerisation conditions, and
6) polymerising the monomer to form a dispersion of microcapsules in the aqueous phase.

8. A dispersion of microcapsules in a liquid in which the microcapsules comprise a hydrophobic core within a polymeric shell, in which the core comprises:
(a) 10 to 65% by weight of a hydrocarbon liquid or hydrocarbon wax containing hydrocarbon molecules of between 10 and 24 carbon chain length; and
(b) 35 to 90% by weight of an aliphatic acid of chain length at least 6 carbon atoms, based on the total weight of the core.

9-10. (canceled)

11. A Thermal energy storage system, thermal energy transfer system or recirculating fluid cooling systems which system further comprise the microcapsules according to claim 1.
